(19) United States
(12) Patent Application Publication
(10) Pub. No.: US 2019/0242524 A1
(43) Pub. Date: Aug. 8, 2019

(54) HIGH PRESSURE CYLINDER

(71) Applicant: SHARPSVILLE CONTAINER CORPORATION, Sharpsville, PA (US)

(72) Inventors: JAMES R. MACNEAL, Burton, OH (US); Charles J. Bachorski, Pittsburgh, PA (US); Michael P. Lewis, Mars, PA (US); Jerry L. Codutti, Sharpsville, PA (US); Faithe E. MacNeal, Burton, OH (US)

(21) Appl. No.: 16/268,039

(22) Filed: Feb. 5, 2019

Related U.S. Application Data
(60) Provisional application No. 62/626,316, filed on Feb. 5, 2018.

(51) Int. Cl. F17C 1/00; F17C 13/04; B21D 39/02

(52) U.S. Cl. CPC F17C 1/00; F17C 13/04; B21D 39/02; F17C 2201/0109; F17C 2221/03; F17C 2205/0332; F17C 2209/2181; F17C 2209/221; F17C 2205/0305; F17C 2203/0643

(57) ABSTRACT

A method for making a cylinder for reactive gas mixtures in the calibration gas segment of the compressed gas market includes cutting a stainless steel tube to a desired length. First and second axial end portions of the cut tube are swaged. A spud is connected to the first swaged axial end portion of the cut tube. A base is connected to the second swaged axial end portion of the cut tube. The cylinder for reactive gas mixtures in the calibration gas segment of the compressed gas market includes a stainless steel tube having first and second swaged axial end portions and a central portion extending between the first and second swaged axial end portions. The spud is connected to the first swaged axial end portion of the tube. The base is connected to the second swaged axial end portion of the tube.

### RELATED APPLICATION

This application claims the benefit of U.S. Provisional Patent Application Ser. No. 62/626,316, filed on Feb. 5, 2018, the disclosure of which is entirely incorporated herein by reference.

### FIELD OF THE INVENTION

The present invention is directed to a high pressure cylinder and, specifically, to a stainless steel high pressure cylinder that provides a stable containment method for reactive gas mixtures in the calibration gas segment of the compressed gas market.

### BACKGROUND OF THE INVENTION

It is known to use extruded aluminum cylinders for storing and shipping high pressure reactive gas mixtures in the calibration gas segment. The aluminum cylinders are limited to a 500 psi operating pressure. Therefore, the aluminum cylinders are not strong enough to handle a large amount of high pressure gas and are not spark resistant.

Water vapor adheres to the interior and exterior cylinder walls via weak intermolecular attractive forces called Van der Waals attraction prior to the cylinder being filled with a reactive gas mixture. The cylinder interior wall is a very uneven surface with nooks, crannies and caverns which also have water adhering to them. Furthermore, the crystal lattice of the metal has interstitial space between its own molecules into which water vapor may adhere. These caverns and interstitial spaces are usually not reachable effectively to remove the water vapor. Thus, each aluminum cylinder must undergo some type of “seasoning” to form a protective barrier between the gas and aluminum cylinder wall. The seasoning process can be either chemical or physical. The seasoning process can take up to three days and may utilize toxic chemicals such as silane to form the protective barrier over the surface irregularities and interstitial spaces to prevent the reactive gas mixture from deteriorating due to the reaction with the water vapor. However, the coating approach does not reach the cavern interiors or the interstitial spaces very well. Therefore, some gas mixes fail at varying periods of time after fill, sometime only taking months to deteriorate.

### SUMMARY OF THE INVENTION

The present invention is directed to a method for making a cylinder for reactive gas mixtures in the calibration gas segment of the compressed gas market including cutting a stainless steel tube to a desired length. First and second axial end portions of the cut tube are swaged. A spud is connected to the first swaged axial end portion of the cut tube. A base is connected to the second swaged axial end portion of the cut tube.

In another aspect of the present invention a cylinder for reactive gas mixtures in the calibration gas segment of the compressed gas market includes a stainless steel tube having first and second swaged axial end portions and a central portion extending between the first and second swaged axial end portions. A spud is connected to the first swaged axial end portion of the tube. A base is connected to the second swaged axial end portion of the tube.

### BRIEF DESCRIPTION OF THE DRAWINGS

The foregoing and other features and advantages of the present invention will become apparent to those skilled in the art to which the present invention relates upon reading the following description with reference to the accompanying drawings in which:

FIG. 1 is a cross-sectional view of a stainless steel cylinder for reactive gas mixtures constructed in accordance with the present invention;

FIG. 2 is a cross-sectional view of a stainless steel tube used to make the cylinder of FIG. 1; and

FIG. 3 is a cross-sectional view of the stainless steel tube of FIG. 2 with the axial ends swaged.

### DESCRIPTION

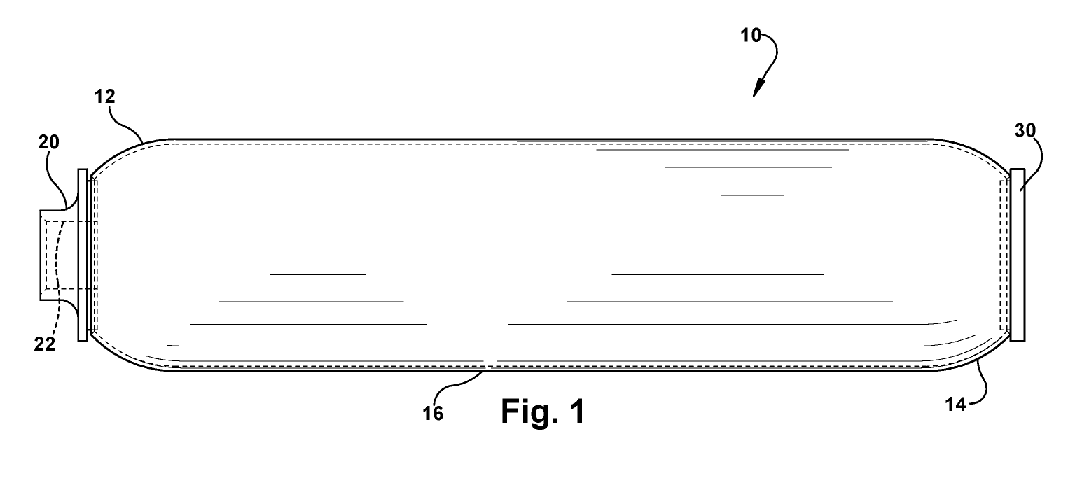

A high pressure cylinder 10 for storing and shipping high pressure reactive gas mixtures in the calibration gas segment constructed in accordance with the present invention is illustrated in FIG. 1. The cylinder 10 is made of stainless steel. The stainless steel material helps prevent reactions within the cylinder 10 that will degrade the reactive gas mixture, which may render the gas useless. It is contemplated that the enclosed gas will remain stable for at least 1 to 2 years, depending on the application, gas mixture and/or prevailing regulations where the cylinder 10 is used.

The cylinder 10 has a first axial end portion 12 and a second axial end portion 14. A cylindrical central portion 16 extends between the first and second end portions 12, 14. The first and second axial end portions 12 and 14 have a smaller diameter than the central portion 16 and taper from the central portion to the axial ends of the cylinder. The first and second axial end portions may be dome shaped or semi-spherically shaped.

A stainless steel spud or top 20 is welded to the first end portion 12 of the cylinder 10. The spud 20 may have a threaded opening 22 for installing a valve on the cylinder 10. A stainless steel base or bottom 30 is welded to the second end portion 14 of the cylinder 10.

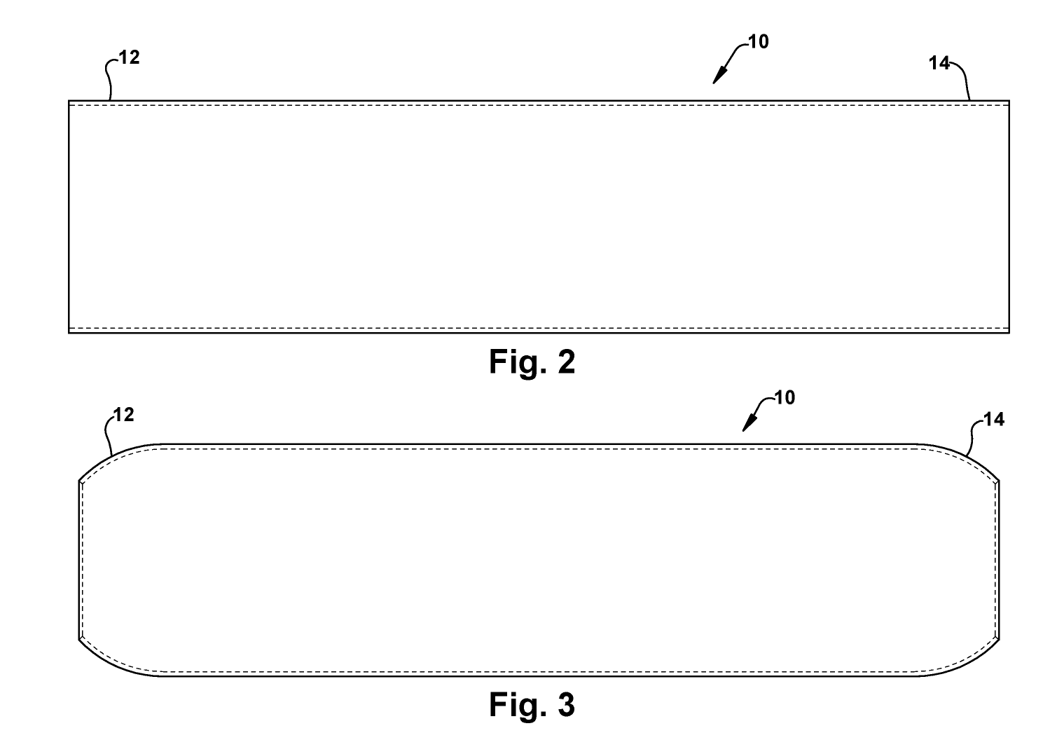

The manufacturing process for the stainless steel cylinder 10 starts with a piece of stainless steel tubing 10 (FIG. 2). The stainless steel tubing 10 may be 304/304L stainless steel. The tubing 10 is cut to a desired length. The tubing 10 may have any desired diameter and be cut to various lengths depending on the required cylinder volume.

The first and second axial end portions 12, 14 of the cut tube 10 are swaged in a press to impart a desired shape to the ends of the tube, as shown in FIG. 3. The first and second end portions 12, 14 may be swaged to reduce the diameter of the cut tube at the first and second ends. It is contemplated that the first and second end portions 12, 14 may be swaged to form dome or semi-spherical shaped ends. Each of the first and second end portions 12, 14 may be swaged to have the same shape or different shapes. The swaging dies are specially designed to accommodate the forming properties of the stainless steel. The cylinder 10 may be washed to remove any swaging lubricant.

The spud or top 20 is welded to the first swaged axial end portion 12 of the cylinder 10. The base or bottom 30 is welded to the second swaged axial end portion 14 of the cylinder 10. The cylinder 10 may be tested using a hydrostatic method or a pressure method to ensure that the welds are sound Sample cylinders 10 may be periodically burst-tested at 2.5 to 3 times maximum operating pressure.

The stainless steel cylinder 10 of the present invention requires much less preparation than an aluminum cylinder before filling with a reactive gas mixture. The stainless steel cylinder 10 may be ready for filling once all of the accumulated moisture and hydrocarbon residue is removed from the interior of the cylinder 10. The moisture and hydrocarbon residue that may be present on the interior of the stainless steel cylinder 10 may be removed by heating the cylinder above 212 LF and cleaning the inside wall with a solvent such as alcohol or xylene. The removal of moisture and carbon residue can be concluded in 24-hours or less.

Furthermore, any water vapor remaining in the cylinder 10 may be removed using the following steps before or after a valve is connected to the stub 20. The cylinder 10 is evacuated. After evacuation, the cylinder may be purged with dry N2 to 50 psig, then vented and evacuated. The cylinder 10 is then heated to approximately 200 L-225 LF, at vacuum for approximately 15-30 minutes to remove surface water. The cylinder 10 is then pressurized to a pressure above what the cylinder is rated to hold with a mixture of 2000 ppm CO2 and balance N2 and held at pressure for 5-10 minutes. For example, the cylinder is pressurized to 1400-1500 psig for a cylinder rated to hold gas at 1000-1100 psi. The cylinder 10 may be held at pressure while at a temperature of 200 L-225 LF. While the cylinder 10 is held at 1400-1500 psig, the cylinder expands, creating (otherwise non-existent) entry into any nooks, crannies, caverns and or interstitial spaces.

If a valve is connected to the stub 20, the valve may have a pressure relief device (burst disc CG-1) that is set at 5/3 service pressure +0/−10%. Therefore, the cylinder 10 with a service pressure of 1000-1100 psi may be safely pressurize to 1400-1500 psig without the pressure relief device activating. The valve may also be made of stainless steel, which has its own nooks and crannies/caverns that need to have the water removed and the process removes the water vapor from the valve also.

The wash gas is vented and the cylinder 10 is evacuated and purged twice with dry N2 to 50 psig immediately venting the purge N2 and a final evacuation. At this point the cylinder 10 is ready for filling with a reactive gas mixture.

The stainless steel cylinder 10 is capable of holding pressures in the 1000-1100 psi range. Therefore, the stainless steel cylinder 10 may double the capacity of an aluminum cylinder having the same size. Thus, the reactive gas mixture is provided to the market in a more cost-effective manner on a per psi basis. Additionally, the stainless steel cylinder 10 is considered spark-resistant so that the stainless steel cylinder may be used in areas where safety is paramount, such as, underground mining and offshore oil rigs.

From the above description of the invention, those skilled in the art will perceive improvements, changes and modifications. Such improvements, changes and modifications within the skill of the art are intended to be covered by the appended claims.

Having described the invention, the following is claimed:

1. A method for making a cylinder for reactive gas mixtures in the calibration gas segment of the compressed gas market comprising:
cutting a stainless steel tube to a desired length;
swaging first and second axial end portions of the cut tube;
connecting a spud to the first swaged axial end portion of the cut tube; and
connecting a base to the second swaged axial end portion of the cut tube.

2. A method for making a cylinder for reactive gas mixtures in the calibration gas segment of the compressed gas market as set forth in claim 1 wherein connecting a spud to the first swaged axial end portion of the cut tube includes connecting a stainless steel spud to the first swaged axial end portion of the cut tube and connecting a base to the second swaged axial end portion of the cut tube include connecting a stainless steel base to the second swaged axial end portion of the cut tube.

3. A method for making a cylinder for reactive gas mixtures in the calibration gas segment of the compressed gas market as set forth in claim 1 wherein swaging the first and second axial end portions of the cut tube includes swaging the first and second axial end portions to have a smaller diameter than a central portion extending between the first and second axial end portions.

4. A method for making a cylinder for reactive gas mixtures in the calibration gas segment of the compressed gas market as set forth in claim 1 wherein swaging the first and second axial end portions of the cut tube includes swaging the first and second axial end portions into a dome shape.

5. A method for making a cylinder for reactive gas mixtures in the calibration gas segment of the compressed gas market as set forth in claim 1 including pressurizing the cylinder to a pressure above what the cylinder is rated to hold with a mixture of 2000 ppm CO2 and balance N2.

6. A method for making a cylinder for reactive gas mixtures in the calibration gas segment of the compressed gas market as set forth in claim 5 including holding the cylinder at the pressure above what the cylinder is rated to hold for 5-10 minutes.

7. A method for making a cylinder for reactive gas mixtures in the calibration gas segment of the compressed gas market as set forth in claim 5 including heating the cylinder 10 to a temperature of 200 L-225 LF while the cylinder is pressurized to the pressure above what the cylinder is rated to hold.

8. A method for making a cylinder for reactive gas mixtures in the calibration gas segment of the compressed gas market as set forth in claim 1 including heating the cylinder to approximately 200 L-225 LF, at vacuum to remove water.

9. A method for making a cylinder for reactive gas mixtures in the calibration gas segment of the compressed gas market as set forth in claim 8 including holding the cylinder at approximately 200 L-225 LF for approximately 15-30 minutes to remove water.

10. A method for making a cylinder for reactive gas mixtures in the calibration gas segment of the compressed gas market as set forth in claim 9 including pressurizing the cylinder to a pressure above what the cylinder is rated to hold with a mixture of 2000 ppm CO2 and balance N2 for 5-10 minutes and heating the cylinder to a temperature of 200 L-225 LF while the cylinder is pressurized to the pressure above what the cylinder is rated to hold.

11. A method for making a cylinder for reactive gas mixtures in the calibration gas segment of the compressed gas market as set forth in claim 5 including connecting a valve to the cylinder prior to heating the cylinder.

12. A cylinder for reactive gas mixtures in the calibration gas segment of the compressed gas market comprising:
a stainless steel tube having first and second swaged axial end portions and a central portion extending between the first and second swaged axial end portions;
a spud connected to the first swaged axial end portion of the tube; and
a base connected to the second swaged axial end portion of the tube.

13. A cylinder as set forth in claim 12 wherein the spud and base are made of stainless steel.

14. A cylinder as set forth in claim 12 wherein the first and second axial end portions have a smaller diameter than the central portion.

15. A cylinder as set forth in claim 14 wherein the first and second axial end portions taper from the central portion to the axial ends of the cylinder.

16. A cylinder as set forth in claim 14 wherein the first and second axial end portions are dome shaped.
